(19) United States
(12) Patent Application Publication
(10) Pub. No.: US 2017/0178632 A1
(43) Pub. Date: Jun. 22, 2017

(54) MULTI-USER UNLOCKING METHOD AND APPARATUS

(71) Applicant: Hisense Mobile Communications Technology Co., Ltd., Qingdao (CN)

(72) Inventors: Xiaohua LI, Qingdao (CN); Shengjie SANG, Qingdao (CN); Wei LIU, Qingdao (CN)

(21) Appl. No.: 15/281,996

(22) Filed: Sep. 30, 2016

(30) Foreign Application Priority Data
Dec. 17, 2015 (CN) 201510947973.0

(51) Int. Cl. G10L 17/22; G10L 17/06; G10L 17/02

(52) U.S. Cl. CPC G10L 17/22; G10L 17/02; G10L 17/06

(57) ABSTRACT

The application discloses a multi-user unlocking method and apparatus, and relates to the field of mobile terminals, where the method includes: receiving, by a terminal device, an input speech signal, and obtaining sound feature parameters of the speech signal; logging into a primary user account upon determining that the sound feature parameters are consistent with primary user sound feature parameters pre-stored by the terminal device; and logging into a guest account upon determining that the sound feature parameters are not consistent with the primary user sound feature parameters pre-stored by the terminal device.

### CROSS-REFERENCE TO RELATED APPLICATION

This application claims the benefit and priority of Chinese Patent Application No. 201510947973.0 filed Dec. 17, 2015. The entire disclosure of the above application is incorporated herein by reference.

### FIELD

The present disclosure relates to the field of mobile terminals, and particularly to a multi-user unlocking method and apparatus.

### BACKGROUND

This section provides background information related to the present disclosure which is not necessarily prior art.

A multi-user management function is supported on many exiting terminal devices along with a growing demand of people. The so-called multi-user management refers to the addition of such a guest account further to a normal access mode of a mobile phone that all the data of a user (an address book, short messages, applications, etc.) are hidden, and a guest can only access and view general functions of the mobile phone. The privacy of the user can be protected in the multi-user management mode without hindering other users from accessing the same terminal device.

### SUMMARY

This section provides a general summary of the disclosure, and is not a comprehensive disclosure of its full scope or all of its features.

Some embodiments of the disclosure provide a multi-user unlocking method including:

receiving an input speech signal;

determining sound feature parameters of the input speech signal according to the speech signal;

logging into a primary user account upon determining that the sound feature parameters are consistent with primary user sound feature parameters pre-stored by a terminal device; and

logging into a guest account upon determining that the sound feature parameters are not consistent with the primary user sound feature parameters pre-stored by the terminal device.

Some embodiments of the disclosure further provide a multi-user unlocking apparatus including:

a receiving module configured to receive an input speech signal;

a sound feature parameter determining module configured to determine sound feature parameters of the input speech signal according to the speech signal;

a first determining module configured to log into a primary user account upon determining that the sound feature parameters are consistent with primary user sound feature parameters pre-stored by a terminal device; and

a second determining module configured to log into a guest account upon determining that the sound feature parameters are not consistent with the primary user sound feature parameters pre-stored by the terminal device.

Some embodiments of the disclosure further provide a terminal device including a memory and one or more processors, wherein the memory is configured to store computer readable program codes, and the processor is configured to execute the computer readable program codes to perform:

receiving an input speech signal;

determining sound feature parameters of the input speech signal according to the speech signal;

logging into a primary user account upon determining that the sound feature parameters are consistent with primary user sound feature parameters pre-stored by the terminal device; and

logging into a guest account upon determining that the sound feature parameters are not consistent with the primary user sound feature parameters pre-stored by the terminal device.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a first flow chart of a multi-user unlocking method according to some embodiments of the disclosure;

FIG. 2 is a second flow chart of a multi-user unlocking method according to some embodiments of the disclosure;

FIG. 3 is a third flow chart of a multi-user unlocking method according to some embodiments of the disclosure;

FIG. 4 is a fourth flow chart of a multi-user unlocking method according to some embodiments of the disclosure;

FIG. 5 is a structural diagram of a multi-user unlocking apparatus according to some embodiments of the disclosure; and

FIG. 6 is a structural diagram of a terminal device according to some embodiments of the disclosure.

Corresponding reference numerals indicate corresponding parts or features throughout the several views of the drawings.

### DETAILED DESCRIPTION

Example embodiments will now be described more fully with reference to the accompanying drawings.

In the embodiments of the disclosure, a terminal device with a multi-user function includes but will not be limited to a mobile phone, a PAD, etc., and for the sake of a convenient description, in the embodiments of the disclosure, a normal access mode of the terminal device (in which a user can view and operate on all the data in the terminal device) will be referred to as a primary user account, and such a guest account will be added further to the normal access mode that data in the primary user account, for which a privacy attribute is set (including but not limited to an address book, short messages, etc.) will be hidden to thereby protect the privacy of the primary user.

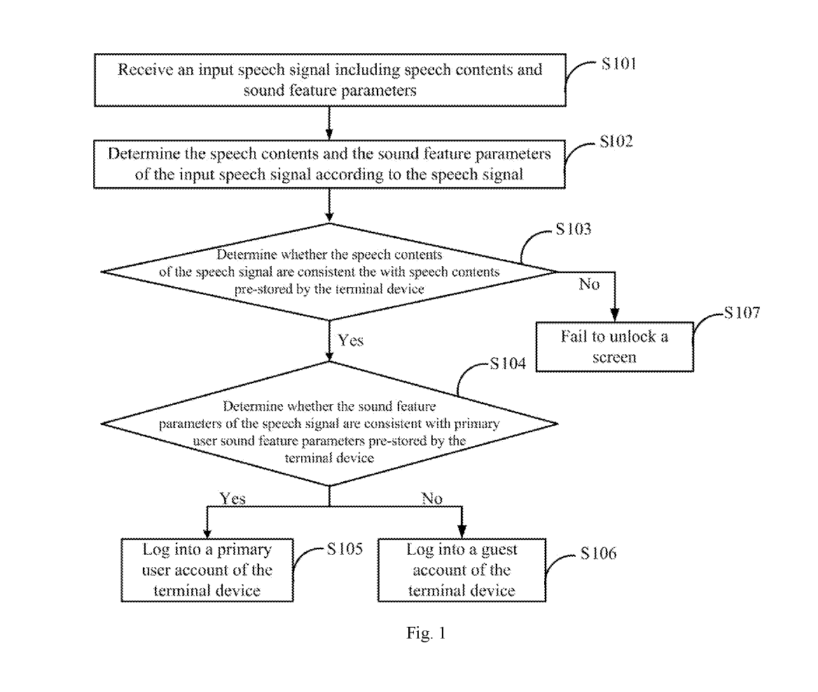

The terminal device with the multi-user function can log into the related account only after it is unlocked, and as illustrated in FIG. 1, a multi-user unlocking method according to some embodiments of the disclosure includes the following operations:

The operation S101 is to receive an input speech signal including speech contents and sound feature parameters.

The operation S102 is to determine the speech contents and the sound feature parameters of the input speech signal according to the speech signal.

The terminal device preprocesses the received user input speech signal, and obtains the speech contents and the sound feature parameters of the unlocking speech signal, where the obtained speech contents of the speech signal are configured for the terminal device to preliminarily determine whether the user has a privilege to access the terminal device, and the obtained sound feature parameters of the speech signal are configured to control the terminal device to enter different user modes.

In some embodiments, the terminal device receives the user input speech signal through an audio input device (e.g., a microphone, etc.), where the terminal devices receives the user input speech signal through a speech recording function with which the terminal device is provided, or receives the user input speech signal through a third-party speech recording disclosure; and the received user input unlocking speech signal can be stored in some specified path in the terminal device.

In some embodiments, the terminal device receives the user input speech signal, and then parses the unlocking speech signal for the speech contents by obtaining a computer readable text or command generated as a result of speech recognition on the speech signal, or obtaining speech feature values generated by extracting the feature values from the unlocking speech signal.

Speech recognition, also referred to as Automatic Speech Recognition (ASR), aims to convert an input human language into a computer readable text or command including a sequence of binary codes or characters. There are three generally common speech recognition methods including a sound channel model and speech knowledge based method, a template matching method, and a human intelligence based method. Speech recognition on the user input speech signal received by the terminal device can generally involve three components of sound feature extraction, acoustic model and pattern matching (a recognition algorithm), and linguistic model and linguistic processing, where the speech feature is a set of feature values extracted from the input speech signal in some algorithm, and the feature values can be digits, numbers , etc., where the most common feature values are Mel-scale Frequency Cepstral coefficients (MFCC); the existing recognition algorithms available include the Dynamic Time Warping (DTW) algorithm, the Hidden Markov Model (HMM) algorithm, the Vector Quantization (VQ) algorithm, etc.

Extraction of the sound feature parameters is similar to extraction of the speech feature values in speech recognition, and common methods of the former are also the same as those of the latter except that the sound feature parameters are extracted by normalizing a feature of a human speaker to remove speech contents, and extracting sound feature information of the human speaker to characterize the timbre, the tone, etc., of the sound.

After the speech contents and the sound feature parameters of the speech signal are determined, it is determined whether the speech contents of the speech signal are consistent with speech contents pre-stored by the terminal device, and the sound feature parameters of the speech signal are consistent with sound feature parameters pre-stored by the terminal device, to thereby determine whether the terminal device logs into a primary user account or a guest account, or is unlocked unsuccessfully. It may be determined firstly whether the speech contents of the speech signal are consistent the with the speech contents pre-stored by the terminal device, and then whether the sound feature parameters of the speech signal are consistent with the sound feature parameters pre-stored by the terminal device; or it may be determined firstly whether the sound feature parameters of the speech signal are consistent with the sound feature parameters pre-stored by the terminal device, and then whether the speech contents of the speech signal are consistent the with pre-stored speech contents pre-stored by the terminal device. The following description will be given by way of an example in which it is determined firstly whether the speech contents of the speech signal are consistent the with the speech contents pre-stored by the terminal device, and then whether the sound feature parameters of the speech signal are consistent with the sound feature parameters pre-stored by the terminal device.

The operation S103 is to determine whether the speech contents of the speech signal are consistent the with speech contents pre-stored by the terminal device.

Here the speech contents pre-stored by the terminal device are obtained as a result of speech recognition on a number of sample speech signals input by a primary user of the terminal device, and the speech contents are text contents of a speech unlocking password of the terminal device, including digits, letters, words, sentences, or a combination thereof, which can be a sequence of computer readable binary codes or characters, etc.; or the speech contents pre-stored by the terminal device correspond to speech feature values obtained by extracting the feature values from a number of sample speech signals, input by the primary user of the terminal device, from which personal information of a human speaker are removed.

In some embodiments, since the speech feature values correspond uniquely to different speech input signals, the speech feature values of the user input speech signal can be compared with the speech feature values pre-stored by the terminal device to determine whether they are consistent in speech contents. The speech feature values can be compared to determine their consistence in speech contents more easily than as obtaining the computer readable text or command a result of speech recognition, and determining their consistence in speech contents. It shall be noted that the speech feature values for recognizing the speech contents need to be normalized to remove personal information of a human speaker (e.g., the timbre thereof). The terminal device receives the user input speech signal, parses the speech signal for the speech feature values, and then retrieves the pre-stored speech feature values from the specified storage location in the terminal device, and compares the obtained speech feature values of the speech signal with the speech feature values pre-stored by the terminal device to determine whether they are consistent. If the obtained speech feature values of the speech signal and the speech feature values pre-stored by the terminal device are not consistent, which indicates that the user inputting the speech signal has no privilege to access the terminal device, then the flow will proceed to the operation S107 to notify the user of the failure with unlocking; if the obtained speech feature values of the speech signal and the speech feature values pre-stored by the terminal device are consistent, the flow will further control an access mode to the terminal device according to the sound feature parameters, including the primary user account and the guest account, which corresponds to the operation S104.

The operation S104 is to determine whether the sound feature parameters of the speech signal are consistent with primary user sound feature parameters pre-stored by the terminal device.

The sound feature parameters are parameters characterizing a feature of a human speaker, and since different persons speak with different timbres and tones, there are different sound feature parameters of the different human speakers, so that the human speaker can be identified and determined according to the sound feature parameters.

If it is determined that the speech contents of the user input speech signal are consistent with the speech contents pre-stored by the terminal device, then the pre-stored primary user sound feature parameters will be further retrieved from the specified storage location in the terminal device, and compared with the sound feature parameters of the speech signal received by the terminal device to determine whether the sound feature parameters of the speech signal are consistent with the primary user sound feature parameters pre-stored by the terminal device. If the sound feature parameters of the speech signal are consistent with the primary user sound feature parameters pre-stored by the terminal device, then it will be determined that the unlocking user is a user which can log into the primary user account of the terminal device, which corresponds to the operation S105; if the sound feature parameters of the speech signal are not consistent with the primary user sound feature parameters pre-stored by the terminal device, it will be determined that the unlocking user is a user which can log into the guest account of the terminal device, which corresponds to the operation S106.

The operation S105 is to log into a primary user account of the terminal device.

If it is determined that the speech contents of the speech signal received by the terminal device are consistent with the speech contents pre-stored by the terminal device, then if it is determined that the sound feature parameters of the unlocking speech signal are consistent with the primary user sound feature parameters pre-stored by the terminal device, then it will be determined that the unlocking user is a primary user, and the terminal device will be unlocked for logging into the primary user account.

The terminal device logging into the primary user account can chose to log into a primary account number or a guest account number, where the primary account number corresponds to an account number of an owner of the terminal device, and the guest account number corresponds to an account number of a guest of the terminal device.

The operation S106 is to log into a guest account of the terminal device.

If it is determined that the speech contents of the speech signal received by the terminal device are consistent with the speech contents pre-stored by the terminal device, then if it is determined that the sound feature parameters of the speech signal are not consistent with the primary user sound feature parameters pre-stored by the terminal device, then it will be determined that the unlocking user is a guest user, and the terminal device will be unlocked for logging into the guest user account.

The operation S107 is to fail to unlock a screen.

If it is determined that the speech contents of the speech signal received by the terminal device are not consistent with the speech contents pre-stored by the terminal device, then the terminal device will notify the user of the failure with unlocking.

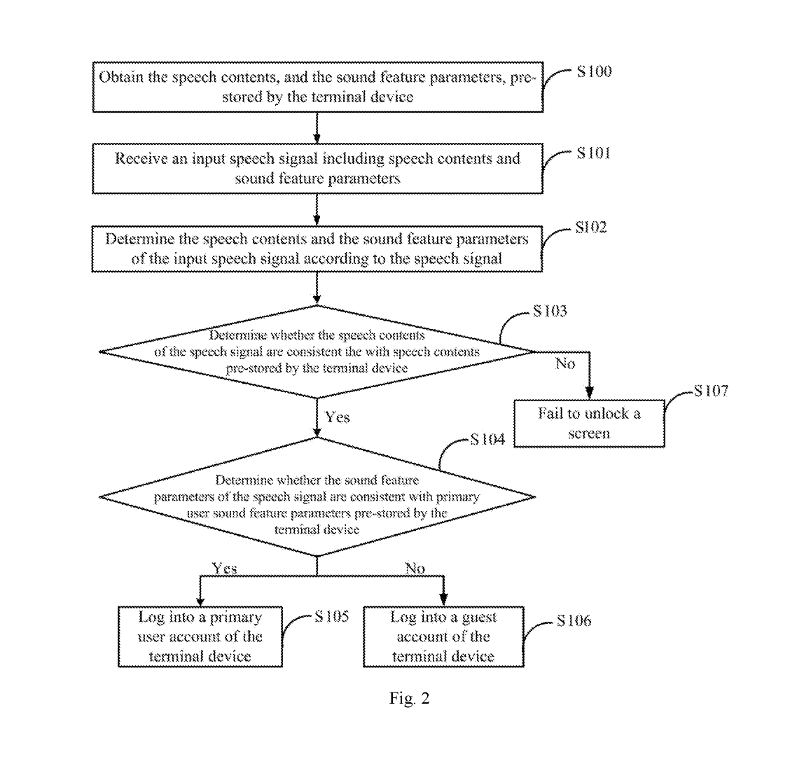

As illustrated in FIG. 2, a multi-user unlocking method according to an embodiment of the disclosure further includes the following operation before the operation S101:

The operation S100 is to obtain the speech contents, and the sound feature parameters, pre-stored by the terminal device.

Particularly the terminal device receives at least one sample speech signal input by the user through an audio input device (e.g., a microphone, etc.), where the at least one sample speech signal corresponds to a speech signal, with the same speech contents, read aloud by the primary user of the terminal device for a number of times, and the speech contents correspond to text contents of an unlocking password of the terminal device, which can include digits, letters, words, sentences, or a combination thereof. For example, if the unlocking password preset by the primary user of the terminal device is “123a”, then the primary user will read aloud “123a” three times when he or she is asked by the terminal device to preset a speech password, where the unlocking password which is read aloud three times corresponds to the at least one sample speech signal above.

The terminal device receives the at least one sample speech signal input by the primary user, and then parses it the speech contents, and the primary user sound feature parameters, pre-stored by the terminal device; and in the example above, the speech contents can be “123a”, or Mel-scale Frequency Cepstral coefficients corresponding to “123a”, and the sound feature parameters can be the timbre of the sample speech signal, or the tone of the sample speech signal, where the speech contents pre-stored by the terminal device are configured for the operation S103 to password unlocking, and the primary user sound feature parameters pre-stored by the terminal device are configured for the operation S104 to control a user mode. Particularly after the terminal device receives the at least one sample speech signal input by the user, the terminal device can process each sample speech signal, obtain speech contents and sound feature parameters of each sample speech signal, and take the speech contents and the sound feature parameters appearing in the respective samples at the highest probability as the speech contents, and the primary user sound feature parameters, pre-stored by the terminal device. The speech contents in this embodiment can be a computer readable text or command generated as a result of speech recognition on a sample speech signal, or speech feature values generated by extracting the feature values from the sample speech signal.

In order to improve the accuracy of the speech contents, and the primary user sound feature parameters, pre-stored by the terminal device, the speech contents, and the primary user sound feature parameters, pre-stored by the terminal device are obtained from a number of sample speech signals input by the primary user.

In the embodiments of the disclosure, after the terminal device receives the input speech signal, i.e., the speech signal including the speech contents and the sound feature parameters, the terminal device compares the speech contents of the speech signal with the speech contents pre-stored by the terminal device to determine their consistency; and further determines whether the sound feature parameters of the unlocking speech signal are consistent with the primary user feature parameters pre-stored by the terminal device, and if the sound feature parameters of the unlocking speech signal are consistent with the primary user feature parameters pre-stored by the terminal device, then the terminal device will log into the primary user account thereof; if the sound feature parameters of the unlocking speech signal are not consistent with the primary user feature parameters pre-stored by the terminal device, the terminal device will log into the guest account thereof In the embodiments of the disclosure, only one speech signal unlocking password needs to be pre-stored, and if the user inputs a speech signal, then the terminal device will identify speech contents and sound feature parameters from the speech signal, where the speech contents of the speech signal are configured to pre-lock the terminal device, and the sound feature parameters of the sound signal are configured to control a user access mode, so that the terminal device with the multi-user function can log respectively into the primary user account and the guest account, thus simplifying the unlocking of the multi-user terminal, and the control on the user mode thereof; and on the other hand, the use of only one speech unlocking password can enable the owner of the terminal device to log into the primary user account without being noticed, to thereby better protect the privacy of the owner, and the security of the password.

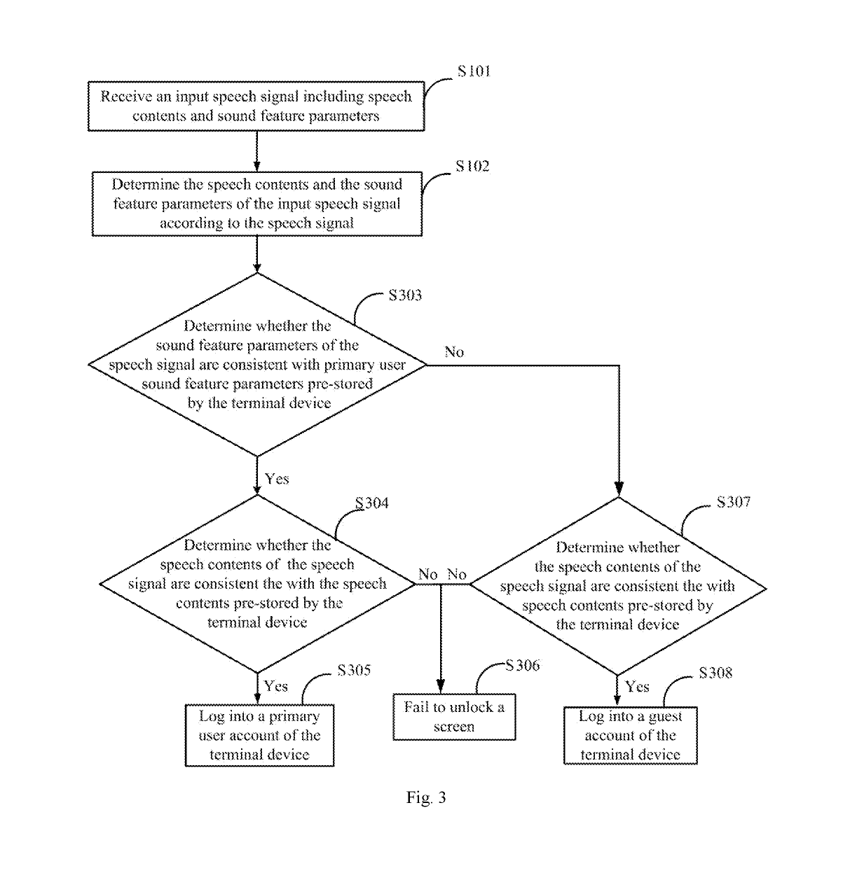

As illustrated in FIG. 3, after the operation S102, the multi-user unlocking will be described as follows by way of an example in which it is determined firstly whether the sound feature parameters of the speech signal are consistent with the sound feature parameters pre-stored by the terminal device, and then whether the speech contents of the speech signal are consistent the with the speech contents pre-stored by the terminal device:

The operation S303 is to determine whether the sound feature parameters of the speech signal are consistent with primary user sound feature parameters pre-stored by the terminal device, and if so, then the flow will proceed to the operation S304; otherwise, the flow will jump to the operation S307.

The operation S304 is to determine whether the speech contents of the speech signal are consistent the with the speech contents pre-stored by the terminal device, and if so, then the flow will proceed to the operation S305; otherwise, the flow will jump to the operation S306.

In some embodiments, since the speech feature values correspond uniquely to different speech input signals, the speech feature values of the user input speech signal can be compared with the speech feature values pre-stored by the terminal device to determine whether they are consistent in speech contents. The speech feature values can be compared to determine their consistence in speech contents more easily than as obtaining the computer readable text or command a result of speech recognition, and determining their consistence in speech contents. It shall be noted that the speech feature values for recognizing the speech contents need to be normalized to remove personal information of a human speaker. The terminal device receives the user input speech signal, parses the speech signal for the speech feature values, and then retrieves the pre-stored speech feature values from the specified storage location in the terminal device, and compares the obtained speech feature values of the speech signal with the speech feature values pre-stored by the terminal device to determine whether they are consistent. If the obtained speech feature values of the speech signal and the speech feature values pre-stored by the terminal device are consistent, which indicates that the user inputting the speech signal has a privilege to access the terminal device, then the flow will proceed to the operation S305 to log into the primary user account; the obtained speech feature values of the speech signal and the speech feature values pre-stored by the terminal device are not consistent, which indicates that the user inputting the speech signal has no privilege to access the terminal device, then the flow will proceed to the operation S306 to notify the user of the failure with unlocking.

The operation S305 is to log into a primary user account of the terminal device.

The operation S306 is to fail to unlock a screen.

The operation S307 is to determine whether the speech contents of the speech signal are consistent the with speech contents pre-stored by the terminal device, and if so, the flow will proceed to the operation S308; otherwise, the flow will proceed to the operation S306.

If it is determined that the sound feature parameters of the speech signal are not consistent with the primary user sound feature parameters pre-stored by the terminal device, which indicates that the user inputting the speech signal is not a primary user but a guest, to further determine whether the guest has a privilege to access the terminal device, and if the speech contents of the speech signal are consistent the with the speech contents pre-stored by the terminal device, which indicates that the guest has a privilege to access the terminal device, then the flow will proceed to the operation S308; otherwise, which indicates that the guest has no privilege to access the terminal device, then the flow will proceed to the operation S306 to notify the user of the failure with reception.

The operation S308 is to log into a guest account of the terminal device.

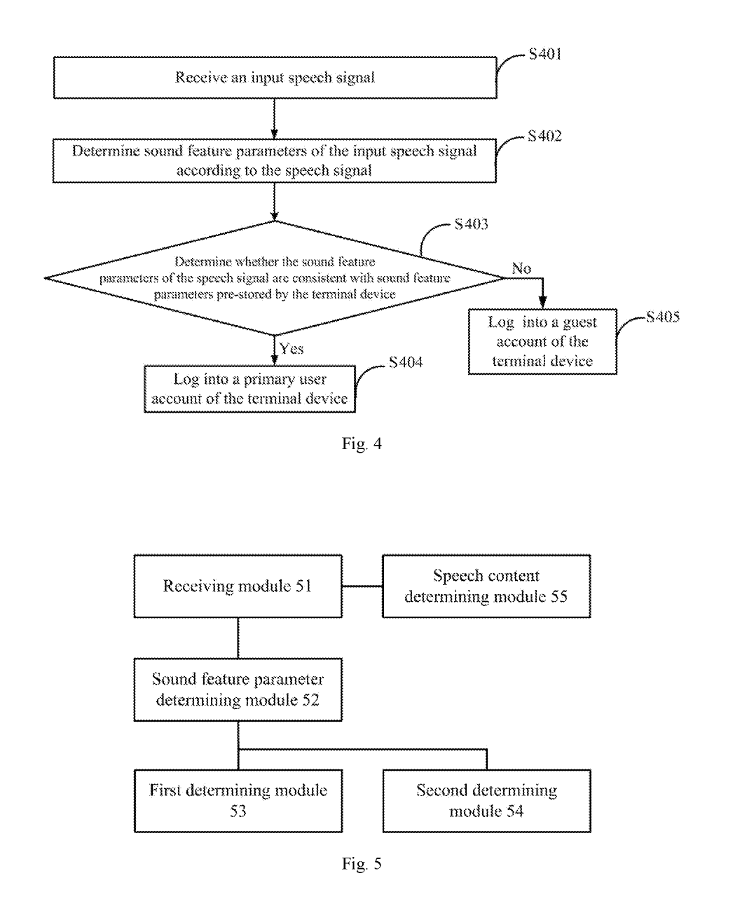

As illustrated in FIG. 4, an embodiment of the disclosure further provides a multi-user unlocking method including the following operations:

The operation S401 is to receive an input speech signal.

The operation S402 is to determine sound feature parameters of the input speech signal according to the speech signal.

A terminal device preprocesses the received user input speech signal, and obtains the sound feature parameters of the input speech signal.

The sound feature parameters are parameters characterizing a feature of a human speaker, and since different persons speak with different timbres and tones, there are different sound feature parameters of the different human speakers, so that the human speaker can be identified and determined according to the sound feature parameters.

The operation S403 is to determine whether the sound feature parameters of the speech signal are consistent with sound feature parameters pre-stored by the terminal device, and if the sound feature parameters of the speech signal are consistent with sound feature parameters pre-stored by the terminal device, then the flow will proceed to the operation S404; the sound feature parameters of the speech signal are not consistent with sound feature parameters pre-stored by the terminal device, the flow will proceed to the operation S405.

Here the sound feature parameters pre-stored by the terminal device are obtained by recognizing the sound feature parameters from a number of sample speech signals input by a primary user of the terminal device.

In some embodiments, the terminal device receives the user input speech signal through an audio input device (e.g., a microphone, etc.), where the terminal devices receives the user input speech signal through a speech recording function with which the terminal device is provided, or receives the user input speech signal through a third-party speech recording application; and the received user input unlocking speech signal can be stored in some specified path in the terminal device.

In some embodiments, the sound feature parameters pre-stored by the terminal device are obtained by acquiring sample speech signals of the user before the input speech signal is received. The terminal devices receives at least one user input sample speech signal, parses the at least one sample speech signal for sound feature parameters, and stores the sound feature parameters.

The terminal device retrieves pre-stored primary user sound feature parameters, i.e., the previously stored sound feature parameters of the sample speech signals, from the specified storage location, and compares them with the speech feature values of the speech signal received by the terminal device to determine whether the sound feature parameters of the speech signal are consistent with the primary user sound feature parameters pre-stored by the terminal device. If so, which indicates that the user inputting the speech signal has a privilege to access the terminal device, then the flow will proceed to the operation S404; otherwise, which indicates that the user inputting the speech signal has no privilege to access the terminal device, then the flow will proceed to the operation S405 to log into a guest account.

The operation S404 is to log into a primary user account of the terminal device.

The operation S405 is to log into a guest account of the terminal device.

If it is determined that speech contents of the received speech signal are not consistent with speech contents pre-stored by the terminal device, then the terminal device will notify the user of the failure with unlocking.

In correspondence to the embodiment of the method above, as illustrated in FIG. 5, some embodiments of the disclosure further provides a multi-user unlocking apparatus including:

A receiving module 51 is configured to receive an input speech signal;

A sound feature parameter determining module 52 is configured to determine sound feature parameters of the input speech signal according to the speech signal;

A first determining module 53 is configured to log into a primary user account upon determining that the sound feature parameters are consistent with primary user sound feature parameters pre-stored by a terminal device; and

A second determining module 54 is configured to log into a guest account upon determining that the sound feature parameters are not consistent with the primary user sound feature parameters pre-stored by the terminal device.

The apparatus further includes:

A speech content determining module 55 is configured to determine speech contents of the input speech signal according to the speech signal after the input speech signal is received;

The first determining module 53 is configured to log into the primary user account upon determining that the sound feature parameters are consistent with the primary user sound feature parameters pre-stored by the terminal device, and that the speech contents are consistent with unlocking speech contents pre-stored by the terminal device; and

The second determining module 54 is configured to log into the guest account upon determining that the sound feature parameters are not consistent with the primary user sound feature parameters pre-stored by the terminal device, and that the speech contents are consistent with the unlocking speech contents pre-stored by the terminal device.

The receiving module 51 is further configured to receive at least one input sample speech signal, to parse the at least one input sample speech signal for speech contents and sound feature parameters, and to store the speech contents and sound feature parameters, before the input speech signal is received.

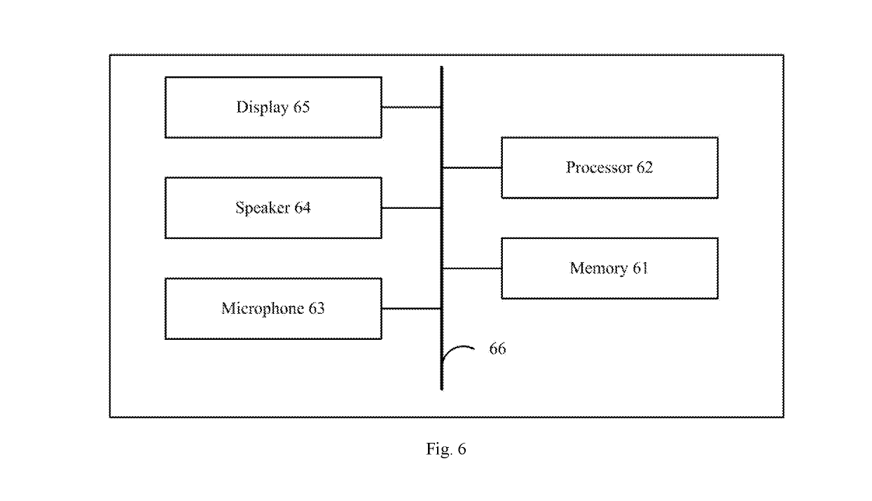

FIG. 6 is a structural block diagram of a terminal device according to some embodiments of the disclosure, where the terminal device includes a memory 61 and one or more processors 62, where the memory is configured to store computer readable program codes, and the processor is configured to execute the computer readable program codes to perform:

Receiving an input speech signal;

Determining sound feature parameters of the input speech signal according to the speech signal;

Logging into a primary user account upon determining that the sound feature parameters are consistent with primary user sound feature parameters pre-stored by the terminal device; and

Logging into a guest account upon determining that the sound feature parameters are not consistent with the primary user sound feature parameters pre-stored by the terminal device.

In some embodiments, the processor 62 is configured to execute the computer readable program codes to perform:

Determining speech contents of the input speech signal according to the speech signal;

Logging into the primary user account upon determining that the sound feature parameters are consistent with the primary user sound feature parameters pre-stored by the terminal device by logging into the primary user account upon determining that the sound feature parameters are consistent with the primary user sound feature parameters pre-stored by the terminal device, and that the speech contents are consistent with unlocking speech contents pre-stored by the terminal device; and

Logging into a guest account upon determining that the sound feature parameters are not consistent with the primary user sound feature parameters pre-stored by the terminal device by logging into the guest account upon determining that the sound feature parameters are not consistent with the primary user sound feature parameters pre-stored by the terminal device, and that the speech contents are consistent with the unlocking speech contents pre-stored by the terminal device.

In some embodiments, the processor 62 is configured to execute the computer readable program codes to perform:

Receiving at least one input sample speech signal before the input speech signal is received; and

Parsing the at least one input sample speech signal for speech contents and sound feature parameters, and storing the speech contents and sound feature parameters.

In some embodiments, the processor 62 is configured to execute the computer readable program codes to perform:

Retrieving speech contents pre-stored by the terminal device; and

Determining whether the speech contents of the speech signal are consistent with the speech contents pre-stored by the terminal device.

In some embodiments, the processor 62 is configured to execute the computer readable program codes to perform:

Retrieving primary user sound feature parameters pre-stored by the terminal device; and

Determining whether the sound feature parameters of the speech signal are consistent with the primary user sound feature parameters pre-stored by the terminal device

In some embodiments, the processor 62 is configured to execute the computer readable program codes to perform:

If it is determined that the speech contents of the speech signal are not consistent with the speech contents pre-stored by the terminal device, to determine a failure with unlocking.

The terminal device further includes a microphone 63, a speaker 64, a display 65, and a line 66 connecting these components.

The memory 61 is configured to store the speech contents, and the sound feature parameters, pre-stored by the terminal device, where the memory is a memory device of the terminal device to store data, and the memory can be an internal memory, e.g., a Read-Only Memory (ROM), a Random Access Memory (ROM), etc.

In some embodiments, the memory 61 can be further configured to store programs for execution related to this embodiment, e.g., program of speech recognition and speaker recognition algorithms.

The microphone 63 is configured to receive a speech signal input by an unlocking user, and at least one sample speech signal input by a primary user, and to transmit them to the processor for processing;

The speaker 64 is configured to receive a command of the processor, to audibly present it to the user, and if the terminal fails to be unlocked, to audibly notify the user.

The display 65 is configured to display a processing result of the processor to the user on a screen.

Those skilled in the art can appreciate clearly that for the sake of convenience and conciseness, reference can be made to the corresponding process in the embodiment of the method above for particular operating processes of the apparatus and the units above, so a repeated description thereof will be omitted here.

In the several embodiments of the disclosure, it shall be appreciated that the disclosed method and apparatus can be embodied otherwise. For example the embodiments of the apparatus described above are merely illustrative, for example, the devices have been just divided into the units in terms of their logical functions, but can be divided otherwise in a real implementation, for example, more than one of the units or the components can be combined or can be integrated into another system, or some of the features can be ignored or may not be implemented. Furthermore the illustrated or described coupling or direct coupling or communication connection between the units or the components can be established via some interfaces, and indirect coupling or communication connection between the devices or units can be electrical, mechanical or in another form.

The units described as separate components may or may not be physically separate, and the components illustrated as units may or may not be physical units, that is, they can be co-located or can be distributed onto a number of network elements. A part or all of the units can be selected for the purpose of the solutions according to the embodiments of the disclosure as needed in reality.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A multi-user unlocking method, comprising:
receiving an input speech signal;
determining sound feature parameters of the input speech signal according to the speech signal;
logging into a primary user account upon determining that the sound feature parameters are consistent with primary user sound feature parameters pre-stored by a terminal device; and
logging into a guest account upon determining that the sound feature parameters are not consistent with the primary user sound feature parameters pre-stored by the terminal device.

2. The method according to claim 1, wherein after the input speech signal is received, the method further comprises:
determining speech contents of the input speech signal according to the speech signal;
logging into the primary user account upon determining that the sound feature parameters are consistent with the primary user sound feature parameters pre-stored by the terminal device comprises:
logging into the primary user account upon determining that the sound feature parameters are consistent with the primary user sound feature parameters pre-stored by the terminal device, and that the speech contents are consistent with unlocking speech contents pre-stored by the terminal device; and
logging into the guest account upon determining that the sound feature parameters are not consistent with the primary user sound feature parameters pre-stored by the terminal device comprises:
logging into the guest account upon determining that the sound feature parameters are not consistent with the primary user sound feature parameters pre-stored by the terminal device, and that the speech contents are consistent with the unlocking speech contents pre-stored by the terminal device.

3. The method according to claim 2, wherein before the input speech signal is received, the method comprises:
receiving at least one input sample speech signal; and
parsing the at least one input sample speech signal for speech contents and sound feature parameters, and storing the speech contents and sound feature parameters

4. The method according to claim 2, wherein the determining that the speech contents of the speech signal are consistent with the speech contents pre-stored by the terminal device comprises:
retrieving the speech contents pre-stored by the terminal device; and
determining whether the speech contents of the speech signal are consistent with the speech contents pre-stored by the terminal device.

5. The method according to claim 1, wherein the determining that the sound feature parameters of the unlocking speech signal are not consistent with the primary user sound feature parameters pre-stored by the terminal device comprises:
retrieving the primary user sound feature parameters pre-stored by the terminal device; and
determining whether the sound feature parameters of the speech signal are consistent with the primary user sound feature parameters pre-stored by the terminal device.

6. The method according to claim 2, wherein the method further comprises:
if it is determined that the speech contents of the speech signal are not consistent with the speech contents pre-stored by the terminal device, then determining a failure with unlocking.

7. A multi-user unlocking apparatus, comprising:
a receiving module configured to receive an input speech signal;
a sound feature parameter determining module configured to determine sound feature parameters of the input speech signal according to the speech signal;
a first determining module configured to log into a primary user account upon determining that the sound feature parameters are consistent with primary user sound feature parameters pre-stored by a terminal device; and
a second determining module configured to log into a guest account upon determining that the sound feature parameters are not consistent with the primary user sound feature parameters pre-stored by the terminal device.

8. The apparatus according to claim 7, wherein the apparatus further comprises:
a speech content determining module configured to determine speech contents of the input speech signal according to the speech signal after the input speech signal is received;
the first determining module is configured to log into the primary user account upon determining that the sound feature parameters are consistent with the primary user sound feature parameters pre-stored by the terminal device, and that the speech contents are consistent with unlocking speech contents pre-stored by the terminal device; and
the second determining module is configured to log into the guest account upon determining that the sound feature parameters are not consistent with the primary user sound feature parameters pre-stored by the terminal device, and that the speech contents are consistent with the unlocking speech contents pre-stored by the terminal device.

9. The apparatus according to claim 8, wherein the receiving module is further configured:
to receive at least one input sample speech signal, to parse the at least one input sample speech signal for speech contents and sound feature parameters, and to store the speech contents and sound feature parameters, before the input speech signal is received.

10. A terminal device, comprising a memory and one or more processors, wherein the memory is configured to store computer readable program codes, and the processor is configured to execute the computer readable program codes to perform:
receiving an input speech signal;
determining sound feature parameters of the input speech signal according to the speech signal;
logging into a primary user account upon determining that the sound feature parameters are consistent with primary user sound feature parameters pre-stored by the terminal device; and
logging into a guest account upon determining that the sound feature parameters are not consistent with the primary user sound feature parameters pre-stored by the terminal device.

11. The terminal device according to claim 10, wherein the processor is further configured to execute the computer readable program codes to perform:
determining speech contents of the input speech signal according to the speech signal;
logging into the primary user account upon determining that the sound feature parameters are consistent with the primary user sound feature parameters pre-stored by the terminal device comprises: logging into the primary user account upon determining that the sound feature parameters are consistent with the primary user sound feature parameters pre-stored by the terminal device, and that the speech contents are consistent with unlocking speech contents pre-stored by the terminal device; and
logging into the guest account upon determining that the sound feature parameters are not consistent with the primary user sound feature parameters pre-stored by the terminal device comprises: logging into the guest account upon determining that the sound feature parameters are not consistent with the primary user sound feature parameters pre-stored by the terminal device, and that the speech contents are consistent with the unlocking speech contents pre-stored by the terminal device.

12. The terminal device according to claim 11, wherein the processor is further configured to execute the computer readable program codes to perform:
receiving at least one input sample speech signal before the input speech signal is received; and
parsing the at least one input sample speech signal for speech contents and sound feature parameters, and storing the speech contents and sound feature parameters

13. The terminal device according to claim 11, wherein the processor is further configured to execute the computer readable program codes to perform:
retrieving the speech contents pre-stored by the terminal device; and
determining whether the speech contents of the speech signal are consistent with the speech contents pre-stored by the terminal device.

14. The terminal device according to claim 10, wherein the processor is further configured to execute the computer readable program codes to perform:
retrieving the primary user sound feature parameters pre-stored by the terminal device; and
determining whether the sound feature parameters of the speech signal are consistent with the primary user sound feature parameters pre-stored by the terminal device.

15. The terminal device according to claim 11, wherein the processor is further configured to execute the computer readable program codes to perform:
if it is determined that the speech contents of the speech signal are not consistent with the speech contents pre-stored by the terminal device, then determining a failure with unlocking.
